(19) United States
(12) Patent Application Publication
(10) Pub. No.: US 2015/0151759 A1
(43) Pub. Date: Jun. 4, 2015

(54) HYBRID VEHICLE AND CONTROL METHOD FOR HYBRID VEHICLE

(71) Applicants: Shunsuke Oyama, Nagakute-shi (JP); Yasunori Umeda, Toyota-shi (JP)

(72) Inventors: Shunsuke Oyama, Nagakute-shi (JP); Yasunori Umeda, Toyota-shi (JP)

(73) Assignee: TOYOTA JIDOSHA KABUSHIKI KAISHA, Toyota-shi, Aichi-ken (JP)

(21) Appl. No.: 14/411,932

(22) PCT Filed: Sep. 17, 2013
(86) PCT No.: PCT/IB2013/002019

§ 371 Date: Dec. 30, 2014

(30) Foreign Application Priority Data
Oct. 2, 2012 (JP) 2012-220461

(51) Int. Cl. B60W 30/184; B60K 6/445; B60W 20/00; B60W 10/06; B60W 10/08

(52) U.S. Cl. CPC B60W 30/1843; B60W 10/06; B60W 10/08; B60W 20/108; B60K 6/445; Y10S 903/93; B60W 2510/244; B60W 2710/0627; B60W 2710/244

(57) ABSTRACT

A control device of a hybrid vehicle is configured to control an engine and a motor such that a battery is charged or discharged and the hybrid vehicle travels on drive power. The control device is configured to execute discharge-oriented control when a temperature of a purification catalyst is higher than or equal to a predetermined temperature. In the discharge-oriented control, the engine and the motor are controlled such that a charging and discharging electric power of the battery increases toward a discharging side when the temperature of the purification catalyst is higher than or equal to the predetermined temperature as compared to when the temperature of the purification catalyst is lower than the predetermined temperature. The predetermined temperature is lower than a degradation promoting lower limit temperature. Stated differently, engine output is reduced to avoid damaging the catalyst.

### BACKGROUND OF THE INVENTION

1. Field of the Invention

The invention relates to a hybrid vehicle and a control method for the hybrid vehicle. More specifically, the invention relates to a hybrid vehicle including an engine in which a purification system having a purification catalyst for purifying exhaust gas is installed in an exhaust system and which is able to output driving power, a motor that is able to output driving power and a battery that is able to exchange electric power with the motor, and a control method for the hybrid vehicle.

2. Description of Related Art

In an existing art, there is proposed a hybrid vehicle of this type having the following configuration. The hybrid vehicle includes an internal combustion engine, an electric motor and a battery. A catalyst is provided in an exhaust passage of the internal combustion engine, and the internal combustion engine is able to output driving power. The electric motor is able to output driving power. The battery is able to exchange electric power with the electric motor. When there is a request to increase the temperature of the catalyst, a region in which the internal combustion engine is stopped and the vehicle is caused to travel with the use of the electric motor is expanded to a higher output side as compared to when there is no such request (for example, see Japanese Patent Application Publication No. 2005-133563 (JP 2005-133563 A)). With the thus configured hybrid vehicle, when there is a request to increase the temperature of the catalyst, a decrease in the temperature of the catalyst is suppressed by suppressing the inflow of low-temperature exhaust gas to the catalyst.

### SUMMARY OF THE INVENTION

In the thus configured hybrid vehicle, it is known that, when the catalyst is exposed to a lean atmosphere at a high temperature, degradation of the catalyst is promoted. Therefore, an increase in catalyst temperature to a temperature range, in which it is assumed that degradation of the catalyst is promoted when exposed to a lean atmosphere, is desirably suppressed as much as possible.

A hybrid vehicle according to the invention suppresses an excessive increase in the temperature of a purification catalyst.

A first aspect of the invention provides a hybrid vehicle. The hybrid vehicle includes an engine, a motor, a battery and a control device. The engine includes a purification system and is configured to output drive power. The purification system is installed in an exhaust system and has a purification catalyst that purifies exhaust gas. The motor is configured to output drive power. The battery is configured to exchange electric power with the motor. The control device is configured to control the engine and the motor such that the hybrid vehicle travels on drive power while the battery is being charged or discharged. The control device is configured to execute discharge-oriented control when a temperature of the purification catalyst is higher than or equal to a predetermined temperature. The predetermined temperature is lower than a degradation promoting lower limit temperature. In the discharge-oriented control, the control device is configured to control the engine and the motor such that a charging and discharging electric power of the battery increases toward a discharging side when the temperature of the purification catalyst is higher than or equal to the predetermined temperature as compared to when the temperature of the purification catalyst is lower than the predetermined temperature.

With the hybrid vehicle according to the invention, the engine and the motor are controlled such that the hybrid vehicle travels on drive power while the battery is being charged or discharged. The discharge-oriented control is executed such that the charging and discharging electric power of the battery increases toward the discharging side as compared to a charging side when the temperature of the purification catalyst is higher than or equal to the predetermined temperature as compared to when the temperature of the purification catalyst is lower than the predetermined temperature. The predetermined temperature is set to a temperature lower than the degradation promoting lower limit temperature of the purification catalyst. Thus, an output from the motor increases and an output from the engine reduces when the temperature of the purification catalyst is higher than or equal to the predetermined temperature as compared to when the temperature of the purification catalyst is lower than the predetermined temperature. Therefore, it is possible to suppress an excessive increase in the temperature of the purification catalyst, that is, an increase in the temperature of the purification catalyst to at or above the degradation promoting lower limit temperature. Here, the “degradation promoting lower limit temperature” means a lower limit of a temperature range in which it is assumed that degradation of the purification catalyst is promoted when exposed to a lean atmosphere. The “predetermined temperature” may be, for example, a temperature slightly lower than the degradation promoting lower limit temperature.

The hybrid vehicle according to the invention may further have the following configuration. The control device is configured to allow fuel cut of the engine when the temperature of the purification catalyst is lower than the degradation promoting lower limit temperature and there is no output request for the engine. The control device is configured not to allow fuel cut of the engine when the temperature of the purification catalyst is higher than or equal to the degradation promoting lower limit temperature and there is no output request for the engine. Thus, when the temperature of the purification catalyst is higher than or equal to the degradation promoting lower limit temperature, it is possible to suppress exposure of the purification catalyst to a lean atmosphere, so it is possible to suppress promotion of degradation of the purification catalyst. In this case, as described above, an increase in the purification catalyst to at or above the degradation promoting lower limit temperature is suppressed by executing the discharge-oriented control when the temperature of the purification catalyst is higher than or equal to the predetermined temperature. Thus, it is possible to suppress the frequency that fuel cut of the engine is not allowed when there is no output request for the engine, so it is possible to suppress deterioration of fuel economy.

The hybrid vehicle according to the invention may further have the following configuration. The control device is configured to control the engine and the motor such that the hybrid vehicle travels on the drive power while an engine required power based on the drive power and a battery required power is being output from the engine. The control device is configured to set the battery required power to a state-of-charge corresponding power when the discharge-oriented control is not executed. The state-of-charge corresponding power is a power such that a state of charge of the battery approaches a target state of charge. The control device is configured to, when the discharge-oriented control is executed, set the battery required power to a power such that the charging and discharging power of the battery increases toward the discharging side as compared to a case where the battery required power is set to the state-of-charge corresponding power.

Furthermore, the hybrid vehicle according to the invention may further have the following configuration. The control device is configured not to execute the discharge-oriented control when the temperature of the purification catalyst is higher than or equal to the predetermined temperature and a vehicle speed is higher than or equal to a predetermined vehicle speed. When the hybrid vehicle travels at a high vehicle speed, the drive power is relatively large, so an output from the engine is relatively large irrespective of whether the discharge-oriented control is executed. Therefore, the temperature of the purification catalyst may increase to at or above the degradation promoting lower limit temperature, for example, when the hybrid vehicle cruises. Thus, by not executing the discharge-oriented control at this time, it is possible to suppress a decrease in the state of charge of the battery.

Alternatively, the hybrid vehicle according to the invention may further have the following configuration. The control device is configured not to execute the discharge-oriented control when the temperature of the purification catalyst is higher than or equal to the predetermined temperature and a state of charge of the battery is lower than a predetermined state of charge. Thus, it is possible to suppress overdischarging of the battery. Here, the predetermined state of charge may be, for example, a state of charge somewhat lower than the target state of charge.

In addition, the hybrid vehicle according to the invention may further have the following configuration. The hybrid vehicle further includes a generator and a planetary gear unit. The generator is configured to exchange electric power with the battery. Three rotating elements of the planetary gear unit are respectively connected to a drive shaft coupled to an axle, an output shaft of the engine and a rotary shaft of the generator. A rotary shaft of the motor is connected to the drive shaft.

A second aspect of the invention provides a control method for a hybrid vehicle. The hybrid vehicle includes an engine, a motor and a battery. The engine includes a purification system and is configured to output drive power. The purification system is installed in an exhaust system and has a purification catalyst that purifies exhaust gas. The motor is configured to output drive power. The battery is configured to exchange electric power with the motor. The control method includes: controlling the engine and the motor such that the hybrid vehicle travels on drive power while the battery is being charged or discharged; and determining whether a temperature of the purification catalyst is higher than or equal to a predetermined temperature lower than a degradation promoting lower limit temperature. Discharge-oriented control is executed when the temperature of the purification catalyst is higher than or equal to the predetermined temperature. In the discharge-oriented control, the engine and the motor are controlled such that a charging and discharging electric power of the battery increases toward a discharging side when the temperature of the purification catalyst is higher than or equal to the predetermined temperature as compared to when the temperature of the purification catalyst is lower than the predetermined temperature.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a configuration view that shows the schematic configuration of a hybrid vehicle according to an embodiment of the invention;

FIG. 2 is a configuration view that shows the schematic configuration of an engine;

FIG. 3 is a flowchart that shows an example of a charge/discharge required power setting routine that is executed by an HVECU of the embodiment;

FIG. 4 is a view that illustrates an example of a charge/discharge required power setting map;

FIG. 5 is a time chart that illustrates an example of time changes of a required power, a catalyst temperature, a catalyst degradation suppression flag, a fuel injection amount and a charge/discharge required power of a battery;

FIG. 6 is a configuration view that shows the schematic configuration of a hybrid vehicle according to an alternative embodiment;

FIG. 7 is a configuration view that shows the schematic configuration of a hybrid vehicle according to an alternative embodiment;

FIG. 8 is a configuration view that shows the schematic configuration of a hybrid vehicle according to an alternative embodiment; and

FIG. 9 is a configuration view that shows the schematic configuration of a hybrid vehicle according to an alternative embodiment.

### DETAILED DESCRIPTION OF EMBODIMENTS

Embodiments of the invention will be described.

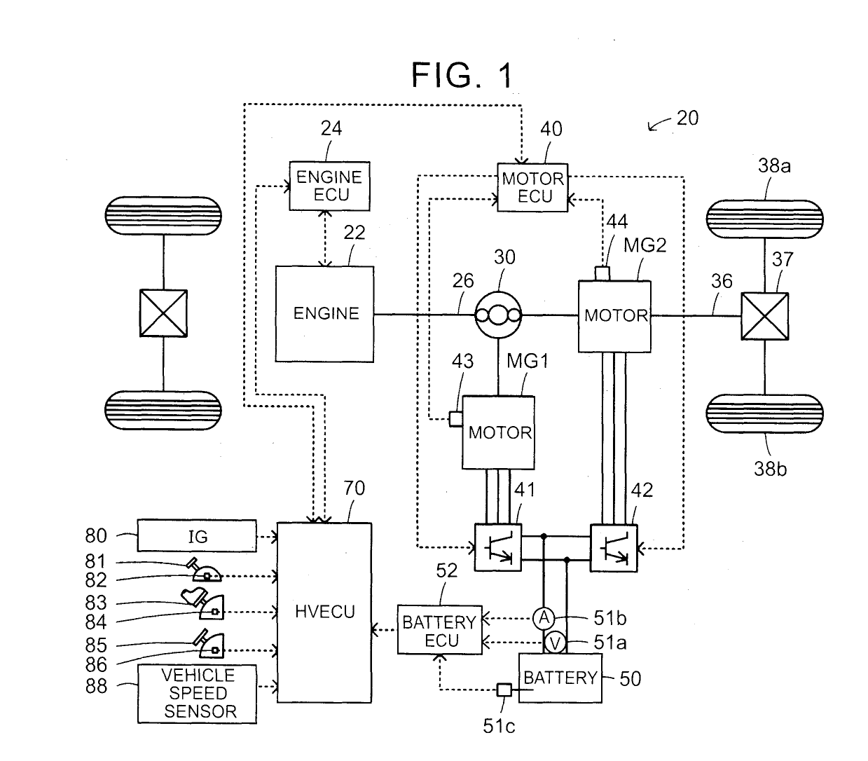

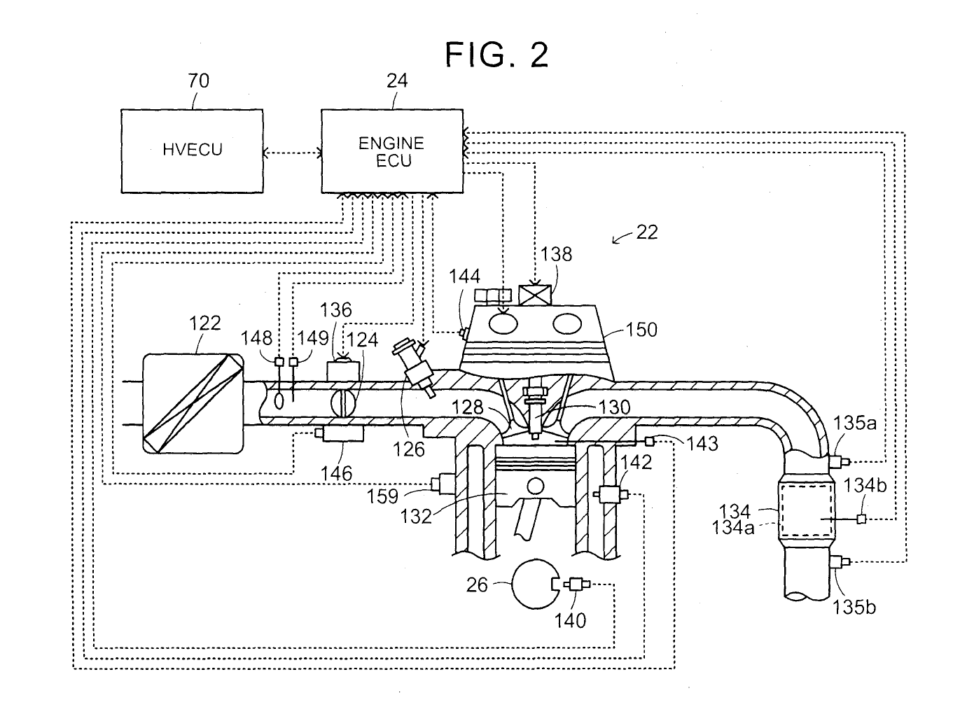

FIG. 1 is a configuration view that shows the schematic configuration of a hybrid vehicle 20 according to an embodiment of the invention. FIG. 2 is a configuration view that shows the schematic configuration of an engine 22. The hybrid vehicle 20 according to the embodiment includes the following configuration as shown in FIG. 1. The hybrid vehicle 20 includes the engine 22, an engine electronic control unit (hereinafter, referred to as engine ECU) 24, a planetary gear unit 30, a motor MG1, a motor MG2, inverters 41, 42, a motor electronic control unit (hereinafter, referred to as motor ECU) 40, a battery 50, a battery electronic control unit (hereinafter, referred to as battery ECU) 52 and a hybrid electronic control unit (hereinafter, referred to as HVECU) 70. The engine 22 outputs power using gasoline, light oil, or the like, as fuel. The engine ECU 24 executes drive control over the engine 22. The carrier of the planetary gear unit 30 is connected to a crankshaft 26 of the engine 22, and the ring gear of the planetary gear unit 30 is connected to a drive shaft 36 coupled to drive wheels 38a, 38b via a differential gear 37. The motor MG1 is, for example, configured as a synchronous generator-motor, and the rotor of the motor MG1 is connected to the sun gear of the planetary gear unit 30. The motor MG2 is, for example, configured as a synchronous generator-motor, and the rotor of the motor MG2 is connected to the drive shaft 36. The inverter 41 is used to drive the motor MG1. The inverter 42 is used to drive the motor MG2. The motor ECU 40 executes drive control over the motors MG1, MG2 by executing switching control over switching elements (not shown) of the inverters 41, 42. The battery 50 is configured as a lithium ion secondary battery, and exchanges electric power with the motors MG1, MG2 via the corresponding inverters 41, 42. The battery ECU 52 manages the battery 50. The HVECU 70 controls the vehicle overall.

As shown in FIG. 2, the engine 22 introduces air, cleaned by an air cleaner 122, via a throttle valve 124. At the same time, the engine 22 injects fuel from a fuel injection valve 126 and mixes the fuel with the introduced air, and then introduces the air-fuel mixture into a combustion chamber via an intake valve 128. The engine 22 explodes and combusts the air-fuel mixture by electric spark generated by an ignition plug 130, and then converts the reciprocal motion of a piston 132 that is pushed down by that energy to the rotational motion of the crankshaft 26. Exhaust gas from the engine 22 is emitted to outside air via a purification system 134 having a purification catalyst (three-way catalyst) 134a that purifies toxic components, such as carbon monoxide (CO), hydrocarbons (HC) and nitrogen oxides (NOx).

Although not shown in the drawing, the engine ECU 24 is configured as a microprocessor mainly formed of a CPU, and, in addition to the CPU, includes a ROM, a RAM, input/output ports and a communication port. The ROM stores a processing program. The RAM temporarily stores data. Signals from various sensors that detect states of the engine 22 are input to the engine ECU 24 via the input port. The signals are, for example, a crank position θcr, a coolant temperature Tw, an in-cylinder pressure Pin, a cam position θca, a throttle position TH, an intake air amount Qa, an intake air temperature Ta, an intake air pressure Pa, a knock signal Ks, a catalyst temperature Tc, an air-fuel ratio AF, an oxygen signal O2, and the like. The crank position θcr is transmitted from a crank position sensor 140 that detects the rotational position of the crankshaft 26. The coolant temperature Tw is transmitted from a coolant temperature sensor 142 that detects the temperature of coolant of the engine 22. The in-cylinder pressure Pin is transmitted from a pressure sensor 143 installed inside the combustion chamber. The cam position θca is transmitted from a cam position sensor 144 that detects the rotational position of a camshaft that opens or closes the intake valve 128 that introduces air into the combustion chamber or an exhaust valve that emits exhaust gas from the combustion chamber. The throttle position TH is transmitted from a throttle valve position sensor 146 that detects the position of the throttle valve 124. The intake air amount Qa is transmitted from an air flow meter 148 installed in an intake pipe. The intake air temperature Ta is transmitted from a temperature sensor 149 similarly installed in the intake pipe. The intake air pressure Pa is transmitted from a pressure sensor that detects the pressure in the intake pipe. The knock signal Ks is transmitted from a knock sensor that is attached to a cylinder block and that detects vibrations that are generated as a result of generation of knocking. The catalyst temperature Tc is transmitted from a temperature sensor 134b that detects the temperature of the purification catalyst 134a of the purification system 134. The air-fuel ratio AF is transmitted from an air-fuel ratio sensor 135a. The oxygen signal O2 is transmitted from an oxygen sensor 135b. In addition, various control signals for driving the engine 22 are output from the engine ECU 24 via the output port. The control signals are, for example, a driving signal to the fuel injection valve 126, a driving signal to a throttle motor 136 that adjusts the position of the throttle valve 124, a control signal to an ignition coil 138 integrated with an igniter, a control signal to a variable valve timing mechanism 150 that is able to change the open/close timing of the intake valve 128, and the like. The engine ECU 24 communicates with the HVECU 70. The engine ECU 24 executes operation control over the engine 22 on the basis of a control signal from the HVECU 70, and, where necessary, outputs data relating to the operating states of the engine 22 to the HVECU 70. The engine ECU 24 performs the following computations. The computations include a computation of the rotation speed of the crankshaft 26, that is, the rotation speed Ne of the engine 22 on the basis of the crank position θcr from the crank position sensor 140, a computation of a volumetric efficiency (the ratio of the volume of air actually introduced in one cycle to a piston displacement per one cycle of the engine 22) KL as the load of the engine 22 on the basis of the intake air amount Qa from the air flow meter 148 and the rotation speed Ne of the engine 22, a computation of the open/close timing VT of the intake valve 128 on the basis of an angle (θci-θcr) made by the cam angle θci of the intake camshaft of the intake valve 128 from the cam position sensor 144 with respect to the crank angle θcr from the crank position sensor 140, a computation of a knock strength Kr indicating the generated level of knocking on the basis of the magnitude and waveform of the knock signal Ks from the knock sensor 159, and the like.

Although not shown in the drawing, the motor ECU 40 is configured as a microprocessor mainly formed of a CPU, and, in addition to the CPU, includes a ROM, a RAM, input/output ports and a communication port. The ROM stores a processing program. The RAM temporarily stores data. Signals that are required to execute drive control over the motors MG1, MG2 are input to the motor ECU 40 via the input port. The signals are, for example, rotational positions θm1, θm2, phase currents, and the like. The rotational positions θm1,θm2 are respectively transmitted from rotational position detection sensors 43, 44 that respectively detect the rotational positions of the rotors of the motors MG1, MG2. The phase currents are applied to the motors MG1, MG2 and detected by a current sensor (not shown). For example, switching control signals that are transmitted to the switching elements (not shown) of the inverters 41, 42 are output from the motor ECU 40 via the output port. In addition, the motor ECU 40 communicates with the HVECU 70. The motor ECU 40 executes drive control over the motors MG1, MG2 through control signals from the HVECU 70, and, where necessary, outputs data relating to the operating states of the motors MG1, MG2 to the HVECU 70. The motor ECU 40 also computes rotation angular velocities ωm1, ωm2 and rotation speeds Nm1, Nm2 of the motors MG1, MG2 on the basis of the rotational positions θm1, θm2 of the rotors of the motors MG1, MG2 from the rotational position detection sensors 43, 44.

Although not shown in the drawing, the battery ECU 52 is configured as a microprocessor mainly formed of a CPU, and, in addition to the CPU, includes a ROM, a RAM, input/output ports and a communication port. The ROM stores a processing program. The RAM temporarily stores data. Signals that are required to manage the battery 50 are input to the battery ECU 52. Where necessary, the battery ECU 52 transmits data relating to the states of the battery 50 to the HVECU 70. The signals are, for example, a terminal voltage Vb, a charge/discharge current Ib, a battery temperature Tb, and the like. The terminal voltage Vb is transmitted from a voltage sensor 51a provided between the terminals of the battery 50. The charge/discharge current Ib is transmitted from a current sensor 51b arranged in a power line connected to the output terminal of the battery 50. The battery temperature Tb is transmitted from a temperature sensor 51c attached to the battery 50. The battery ECU 52 performs the following computations on the basis of an accumulated value of the charge/discharge current Ib detected by the current sensor in order to manage the battery 50. For example, the battery ECU 52 computes a state of charge SOC that is the percentage of the level of electric power that is dischargeable from the battery 50 with respect to the full level at that time. The battery ECU 52 computes input/output limits Win, Wout on the basis of the computed state of charge SOC and the battery temperature Tb. The input limit Win is a maximum permissible electric power at which the battery 50 may be charged. The output limit Wout is a maximum permissible electric power at which the battery 50 may be discharged. It is possible to set the input/output limits Win, Wout of the battery 50 as follows. Basic values of the input/output limits Win, Wout are set on the basis of the battery temperature Tb, an output limit correction coefficient and an input limit correction coefficient are set on the basis of the state of charge SOC of the battery 50, and then the set basic values of the input/output limits Win, Wout are multiplied by the respective correction coefficients.

The HVECU 70 is configured as a microprocessor mainly formed of a CPU, and, in addition to the CPU, includes a ROM, a RAM, a flash memory, input/output ports and a communication port. The ROM stores a processing program. The RAM temporarily stores data. The flash memory stores and holds data. The following signals are input to the HVECU 70 via the input port. The signals are, for example, an ignition signal, a shift position SP, an accelerator operation amount Acc, a brake pedal position BP, a vehicle speed V, and the like. The ignition signal is transmitted from an ignition switch 80. The shift position SP is transmitted from a shift position sensor 82 that detects the operating position of a shift lever 81. The accelerator operation amount Acc is transmitted from an accelerator pedal position sensor 84 that detects the depression amount of an accelerator pedal 83. The brake pedal position BP is transmitted from a brake pedal position sensor 86 that detects the depression amount of a brake pedal 85. The vehicle speed V is transmitted from a vehicle speed sensor 88. As described above, the HVECU 70 is connected to the engine ECU 24, the motor ECU 40 and the battery ECU 52 via the communication port, and exchanges various control signals and data with the engine ECU 24, the motor ECU 40 and the battery ECU 52. The shift position SP includes a parking position, a neutral position, a forward travelling drive position, a reverse travelling reverse position, and the like.

The thus configured hybrid vehicle 20 according to the embodiment calculates a required torque Tr*, which should be output to the drive shaft 36, on the basis of the accelerator operation amount Acc, corresponding to the driver's depression amount of the accelerator pedal, and the vehicle speed V. The hybrid vehicle 20 executes operation control over the engine 22, the motor MG1 and the motor MG2 such that a required power corresponding to the required torque Tr* is output to the drive shaft 36. The operation control over the engine 22, the motor MG1 and the motor MG2 includes a torque conversion operation mode, a charge/discharge operation mode, a motor operation mode, and the like. In the torque conversion operation mode, the engine 22 is subjected to operation control such that a power equivalent to the required power is output from the engine 22, and the motor MG1 and the motor MG2 are subjected to operation control such that all the power that is output from the engine 22 is converted into torque by the planetary gear unit 30, the motor MG1 and the motor MG2 and is output to the drive shaft 36. In the charge/discharge operation mode, the engine 22 is subjected to operation control such that a power equivalent to the sum of the required power and an electric power that is required to charge or discharge the battery 50 is output from the engine 22, and the motor MG1 and the motor MG2 are subjected to drive control such that all or part of the power that is output from the engine 22 while the battery 50 is charged or discharged is converted to torque by the planetary gear unit 30, the motor MG1 and the motor MG2 and the required power is output to the drive shaft 36. In the motor operation mode, operation control is executed such that the operation of the engine 22 is stopped and a power equivalent to the required power from the motor MG2 is output to the drive shaft 36. The torque conversion operation mode and the charge/discharge operation mode each are a mode in which the engine 22, the motor MG1 and the motor MG2 are controlled such that the required power is output to the drive shaft 36 with the operation of the engine 22. There is no substantial difference in control therebetween, so both are referred to as engine operation mode hereinafter.

In the motor operation mode, the HVECU 70 sets the required torque Tr*, which should be output to the drive shaft 36, on the basis of the accelerator operation amount Acc and the vehicle speed V. Subsequently, the HVECU 70 sets 0 for the torque command Tm1* of the motor MG1 and sets the torque command Tm2* of the motor MG2 within the input/output limits Win, Wout of the battery 50 such that the required torque Tr* is output to the drive shaft 36, and then transmits the torque commands Tm1*, Tm2* to the motor ECU 40. The motor ECU 40 that has received the torque commands Tm1*, Tm2* executes switching control over the switching elements of the inverters 41, 42 such that the motors MG1, MG2 are respectively driven in accordance with the torque commands Tm1*, Tm2*. Through such control, the hybrid vehicle 20 is able to travel by outputting the required torque Tr* to the drive shaft 36 within the range of the input/output limits Win, Wont of the battery 50 in a state where the operation of the engine 22 is stopped.

In the engine operation mode, the HVECU 70 sets the required torque Tr*, which should be output to the drive shaft 36, on the basis of the accelerator operation amount Acc from the accelerator pedal position sensor 84 and the vehicle speed V from the vehicle speed sensor 88. Subsequently, the HVECU 70 calculates a drive power Pdrv*, which is required for travelling, by multiplying the set required torque Tr* by the rotation speed Nr of the drive shaft 36, and sets a required power Pe*, which is a power that should be output from the engine 22, by subtracting a charge/discharge required power Pb* of the battery 50 from the calculated drive power Pdrv*. The rotation speed Nr is, for example, a rotation speed that is obtained by multiplying the rotation speed Nm2 of the motor MG2 or the vehicle speed V by a conversion coefficient. The charge/discharge required power Pb* is positive when the battery 50 is discharged. Then, the HVECU 70 sets a target rotation speed Ne* and target torque Te* of the engine 22 using an operation line that serves as the correlation between the rotation speed Ne and torque Te of the engine 22, at which it is possible to efficiently output the required power Pe* from the engine 22. The operation line is, for example, a fuel economy optimal operation line. The HVECU 70 sets a torque command Tm1* that is a torque that should be output from the motor MG1 through rotation speed feedback control for bringing the rotation speed Ne of the engine 22 into coincidence with the target rotation speed Ne* within the range of the input/output limits Win, Wout of the battery 50. At the same time, the HVECU 70 sets a torque command Tm2* of the motor MG2 by subtracting a torque, which acts on the drive shaft 36 via the planetary gear unit 30 when the motor MG1 is driven in accordance with the torque command Tm1*, from the required torque Tr*. The HVECU 70 transmits the set target rotation speed Ne* and target torque Te* to the engine ECU 24, and transmits the torque commands Tm1*, Tm2* to the motor ECU 40. The engine ECU 24 that has received the target rotation speed Ne* and the target torque Te* executes the following control such that the engine 22 is operated at the target rotation speed Ne* and the target torque Te*. The controls are, for example, intake air amount control for adjusting the intake air amount by adjusting the opening degree of the throttle valve 124, fuel injection control for adjusting the fuel injection amount from the fuel injection valve 126, ignition control for controlling the ignition timing of the ignition plug 130, and the like. The motor ECU 40 that has received the torque commands Tm1*, Tm2* executes switching control over the switching elements of the inverters 41, 42 such that the motors MG1, MG2 are respectively driven in accordance with the torque commands Tm1*, Tm2*. Through the above controls, the hybrid vehicle 20 is able to travel by outputting the required torque Tr* to the drive shaft 36 within the range of the input/output limits Win, Wout of the battery 50 while efficiently operating the engine 22.

While the hybrid vehicle 20 according to the embodiment is travelling in the engine operation mode, the HVECU 70 sets a catalyst degradation suppression flag Fc to 0 when the catalyst temperature Tc detected by the temperature sensor 134b and input through communication from the engine ECU 24 is lower than a degradation promoting lower limit temperature Tcdmin, and sets the catalyst degradation suppression flag Fc to 1 when the catalyst temperature Tc is higher than or equal to the degradation promoting lower limit temperature Tcdmin, and then transmits the catalyst degradation suppression flag Fc to the engine ECU 24. The degradation promoting lower limit temperature Tcdmin is a lower limit of a temperature range in which it is assumed that degradation of the purification catalyst 143a is promoted when exposed to a lean atmosphere, and is, for example, set to 780° C., 800° C., 820° C., or the like. The engine ECU 24 that has received the catalyst degradation suppression flag Fc carries out fuel cut of the engine 22 in order to improve fuel economy when the catalyst degradation suppression flag Fc is 0 at the time when there is no output request for the engine 22. The time when there is no output request is, for example, the time when a driver sets the accelerator off. When the catalyst degradation suppression flag Fc is 1, the engine ECU 24 executes catalyst degradation suppression control for continuing explosion and combustion of air-fuel mixture by carrying out fuel injection such that the injected fuel is stoichiometric with respect to the intake air amount of the engine 22 in order not for the purification catalyst 134a to be exposed to a lean atmosphere. The catalyst degradation suppression control is, for example, idle operation, or the like. In the latter case, it is possible to suppress degradation of the purification catalyst 134a; however, fuel economy slightly deteriorates.

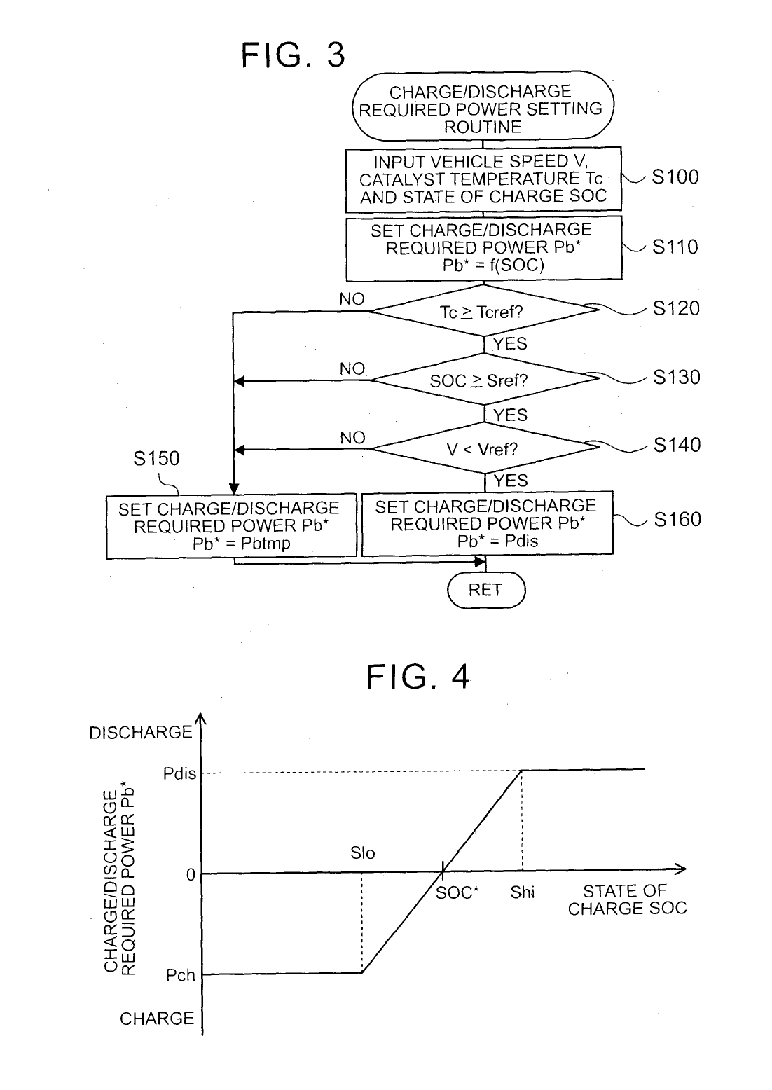

Next, the operation of the thus configured hybrid vehicle 20 according to the embodiment, particularly, the operation at the time of setting the charge/discharge required power Pb* of the battery 50, will be described. FIG. 3 is a flowchart that shows an example of a charge/discharge required power setting routine that is executed by the HVECU 70 according to the embodiment. The routine is repeatedly executed at predetermined time intervals (for example, intervals of several milliseconds).

When the charge/discharge required power setting routine is executed, the HVECU 70 initially executes the process of inputting data, such as the vehicle speed V from the vehicle speed sensor 88, the catalyst temperature Tc and the state of charge SOC of the battery 50 (S100). Here, the catalyst temperature Tc is detected by the temperature sensor 134b, and the catalyst temperature Tc is input from the engine ECU 24 to the HVECU 70 through communication. In, addition, the state of charge SOC of the battery 50 is computed on the basis of an accumulated value of the charge/discharge current Ib detected by the current sensor 51b, and the state of charge SOC is input from the battery ECU 52 to the HVECU 70 through communication.

When the data are input in this way, the HVECU 70 sets a basic charge/discharge required power Pbtmp as a basic value of the charge/discharge required power Pb* of the battery 50 on the basis of the input state of charge SOC of the battery 50 (S110). Here, in the embodiment, the correlation between the state of charge SOC of the battery 50 and the basic charge/discharge required power Pbtmp is predetermined and stored in the ROM (not shown) as a basic charge/discharge required power setting map, and, when the state of charge SOC, of the battery 50 is acquired, the HVECU 70 derives and sets the corresponding basic charge/discharge required power Pbtmp from the stored map. FIG. 4 shows an example of the basic charge/discharge required power setting map. In the example of FIG. 4, when the state of charge SOC of the battery 50 is a target state of charge SOC*, 0 is set for the basic charge/discharge required power Pbtmp. The target state of charge SOC* is, for example, 55%, 60%, 65%, or the like. When the state of charge SOC of the battery 50 is higher than the target state of charge SOC* and is lower than a predetermined percentage Shi, a value having a tendency to increase toward a positive predetermined electric power Pdis as the state of charge SOC increases is set for the basic charge/discharge required power Pbtmp. The predetermined percentage Shi is, for example, set to 70%, 75%, 80%, or the like, and the predetermined electric power Pdis is, for example, set to +2 kW, +3 kW, +5 kW, or the like. When the state of charge SOC is higher than or equal to the predetermined percentage Shi, the predetermined electric power Pdis is set for the basic charge/discharge required power Pbtmp. When the state of charge SOC of the battery 50 is lower than the target state of charge SOC* and is higher than a predetermined percentage Slo, a value having a tendency to reduce toward a negative predetermined electric power Pch as the state of charge SOC decreases is set for the basic charge/discharge required power Pbtmp. The predetermined percentage Slo is, for example, set to 40%, 45%, 50%, or the like, and the predetermined electric power Pch is, for example, set to −2 kW, −3 kW, −5 kW, or the like. When the state of charge SOC is lower than or equal to the percentage Slo, the predetermined electric power Pch is set for the basic charge/discharge required power Pbtmp. That is, in the example of FIG. 4, the basic charge/discharge required power Pbtmp is set such that the state of charge SOC of the battery 50 approaches the target state of charge SOC*.

Subsequently, the catalyst temperature Tc is compared with a threshold Tcref that is a temperature slightly lower than the degradation promoting lower limit temperature Tcdmin (S120). When the catalyst temperature Tc is lower than the threshold Tcref, the basic charge/discharge required power Pbtmp is set for the charge/discharge required power Pb* (S150), and then the routine ends. Here, the threshold Tcref may be, for example, 700° C., 720° C., 750° C., or the like. When the charge/discharge required power Pb* of the battery 50 is set in this way, the engine 22 and the motors MG1, MG2 are controlled such that the required power Pe* obtained by subtracting the charge/discharge required power Pb* of the battery 50 from the drive power Pdrv* is output from the engine 22 and the required torque Tr* is output to the drive shaft 36 as described above when the vehicle travels in the engine operation mode. In this case, the battery 50 is charged or discharged such that the state of charge SOC approaches the target state of charge SOC*. Here, the required torque Tr* is the drive power Pdrv*.

When the catalyst temperature Tc is higher than or equal to the threshold Tcref in S120, the state of charge SOC of the battery 50 is compared with a threshold Sref (S130). Then, the vehicle speed V is compared with a threshold Vref (S140). Here, the threshold Sref may be, for example, a value somewhat lower than the target state of charge SOC*, such as the predetermined percentage Slo and the state of charge SOC slightly larger than the predetermined percentage Slo. The threshold Vref may be, for example, 110 km/h, 120 km/h, 130 km/h, or the like.

When the state of charge SOC of the battery 50 is higher than or equal to the threshold Sref and the vehicle speed V is lower than the threshold Vref, not the basic charge/discharge required power Pbtmp but the predetermined electric power Pdis is set for the charge/discharge required power Pb* of the battery 50 (S160), and then the routine ends. In this case, the battery 50 is discharged at the predetermined electric power Pdis. Thus, considering the case where the state of charge SOC of the battery 50 is higher than or equal to the threshold Sref and lower than the predetermined percentage Shi, a discharging electric power from the battery 50 increases and an output from the engine 22 reduces as compared to those in the case where the catalyst temperature Tc is lower than the threshold Tcref. Therefore, it is possible to suppress an increase in the catalyst temperature Tc to at or above the degradation promoting lower limit temperature Tcdmin higher than the threshold Tcref. Here, the discharging electric power from the battery 50 is an output from the motor MG2. Thus, it is possible to suppress the frequency that the HVECU 70 sets the catalyst degradation suppression flag Fc to 1, so it is possible to carry out fuel cut of the engine 22 without catalyst degradation suppression control when there is no output request for the engine 22, and it is possible to suppress consumption of fuel in the engine 22. That is, it is possible to suppress deterioration of fuel economy.

When the state of charge SOC of the battery 50 is lower than the threshold Sref in S130, the basic charge/discharge required power Pbtmp is set for the charge/discharge required power Pb* (S150), and then the routine ends. When the state of charge SOC of the battery 50 is lower than the threshold Sref (<SOC*), a negative value is set for the basic charge/discharge required power Pbtmp in S110. The negative value is a charging-side value. At this time, if the predetermined electric power Pdis is set for the charge/discharge required power Pb*, the state of charge SOC of the battery 50 may excessively decrease, so, in the present embodiment, in order to suppress the excessive decrease in the state of charge SOC, not the predetermined electric power Pdis but the basic charge/discharge required power Pbtmp is set for the charge/discharge required power Pb*. An excessive decrease in the state of charge SOC of the battery 50 means that the battery 50 is overdischarged.

When the vehicle speed V is higher than or equal to the threshold Vref in S140, as in the case where the state of charge SOC of the battery 50 is lower than the threshold Sref, the basic charge/discharge required power Pbtmp is set for the charge/discharge required power Pb* (S150), and then the routine ends. When the vehicle speed V, that is, the rotation speed Nr of the drive shaft 36, is relatively high, the drive power Pdrv* (=Tr*·Nr) is relatively large. Therefore, for example, while the vehicle is cruising at a high vehicle speed, when the predetermined electric power Pdis is set for the charge/discharge required power Pb*, a period of time required until the catalyst temperature Tc increases to at or above the degradation promoting lower limit temperature Tcmin extends as compared to when the basic charge/discharge required power Pbtmp is set for the charge/discharge required power Ph*. However, even when any one of the predetermined electric power Pdis and the basic charge/discharge required power Pbtmp is set for the charge/discharge required power Pb*, the catalyst temperature Tc may increase to at or above the degradation promoting lower limit temperature Tcmin. In the embodiment, when the catalyst temperature Tc is higher than or equal to the threshold Tcref and the vehicle speed V is higher than or equal to the threshold Vref, the basic charge/discharge required power Pbtmp is set for the charge/discharge required power Pb*. Thus, it is possible to suppress a significant decrease in the state of charge SOC of the battery 50 as compared to the target state of charge SOC*. A lower limit of a predetermined vehicle speed range may be used as the above-described threshold Vref even when any one of the predetermined electric power Pdis and the basic charge/discharge required power Pbtmp is set for the charge/discharge required power Pb*. The predetermined vehicle speed range is a vehicle speed range in which the catalyst temperature Tc may increase to at or above the degradation promoting lower limit temperature Tcmin, for example, when the vehicle is cruising.

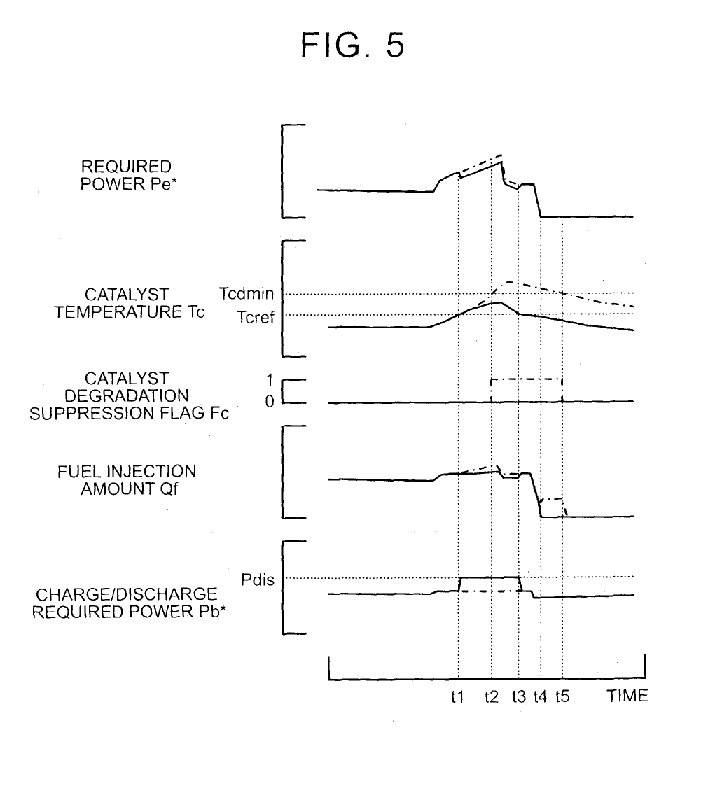

FIG. 5 is a time chart that illustrates an example of time changes of the required power Pe*, the catalyst temperature Tc, the catalyst degradation suppression flag Fc, the fuel injection amount Qf and the charge/discharge required power Pb* of the battery 50 when the state of charge SOC of the battery 50 is higher than or equal to the threshold Sref and lower than the predetermined percentage Shi and the vehicle speed V is lower than the threshold Vref. In the time chart, the solid lines indicate the changes of the embodiment in which the basic charge/discharge required power Pbtmp is set for the charge/discharge required power Pb* when the catalyst temperature Tc is lower than the threshold Tcref and the predetermined electric power Pdis is set for the charge/discharge required power Pb* when the catalyst temperature Tc is higher than or equal to the threshold Tcref. In the time chart, the alternate long and short dashed lines indicate the changes of a comparative embodiment in which the basic charge/discharge required power Pbtmp is set for the charge/discharge required power Pb* irrespective of whether the catalyst temperature Tc is higher than or equal to the threshold Tcref. In the comparative embodiment, as indicated by the alternate long and short dashed lines in the time chart, when the catalyst temperature Tc reaches the threshold Tcref or above at time t1 and the required power Pe* increases thereafter, the fuel injection amount Qf increases accordingly, and the catalyst temperature Tc further increases. When the catalyst temperature Tc reaches the degradation promoting lower limit temperature Tcdmin or above at time t2, the catalyst degradation suppression flag Fc is set to 1. After that, even when the required power Pe* decreases and there is no output request for the engine 22 at time t4, while the catalyst temperature Tc is higher than or equal to the degradation promoting lower limit temperature Tcmin, the catalyst degradation suppression flag Fc is held at 1, and idle operation is carried out without carrying out fuel cut of the engine 22. Then, when the catalyst temperature Tc reaches a temperature below the degradation promoting lower limit temperature Tcmin at time t5 and the catalyst degradation suppression flag Fc is changed from 1 to 0, fuel cut of the engine 22 is carried out. On the other hand, in the embodiment, as indicated by the solid lines in the time chart, when the catalyst temperature Tc reaches the threshold Tcref or above at time t1, the predetermined electric power Pdis is set for the charge/discharge required power Pb*, so, in comparison with the comparative embodiment, the required power Pe* of the engine 22 reduces, and the fuel injection amount Qf reduces. Thus, it is possible to suppress an increase in the catalyst temperature Tc to at or above the degradation promoting lower limit temperature Tcmin. Then, when the catalyst temperature Tc reaches a temperature below the threshold Tcref at time t3, the charge/discharge required power Pb* is changed from the predetermined electric power Pdis to the basic charge/discharge required power Pbtmp. In addition, the catalyst degradation suppression flag Fc is held at 0 when the catalyst temperature Tc does not reach the degradation promoting lower limit temperature Tcmin or above, so, when there is no output request for the engine 22 at time t4, fuel cut of the engine 22 is immediately carried out. Thus, it is possible to suppress deterioration of fuel economy.

With the above-described hybrid vehicle 20 according to the embodiment, when the catalyst temperature Tc is higher than or equal to the threshold Tcref lower than the degradation promoting lower limit temperature Tcmin, the charge/discharge required power Pb* is set so as to be larger than that when the catalyst temperature Tc is lower than the threshold Tcref. Then, the engine 22 and the motors MG1, MG2 are controlled such that the required power Pe* obtained by subtracting the charge/discharge required power Pb* from the drive power Pdrv* is output from the engine 22 and the vehicle travels on the required torque Tr* (drive power Pdrv*), so it is possible to suppress an increase in the catalyst temperature Tc to at or above the degradation promoting lower limit temperature Tcmin. As a result, it is possible to suppress deterioration of fuel economy with the following configuration. When there is no output request for the engine 22, fuel cut of the engine 22 is carried out in order to improve fuel economy when the catalyst temperature Tc is lower than the degradation promoting lower limit temperature Tcmin, and catalyst degradation suppression control (for example, idle operation) is carried out in order for the purification catalyst 134a not to be exposed to a lean atmosphere when the catalyst temperature Tc is higher than or equal to the degradation promoting lower limit temperature Tcmin.

In the hybrid vehicle 20 according to the embodiment, the predetermined electric power Pdis is set to the charge/discharge required power Pb* when the catalyst temperature Tc is higher than or equal to the threshold Tcref, the state of charge SOC of the battery 50 is higher than or equal to the threshold Sref and the vehicle speed V is lower than the threshold Vref. However, a value (Pbtmp+α) obtained by adding a positive predetermined value α to the basic charge/discharge required power Pbtmp may be set to the charge/discharge required power Pb*. Here, the predetermined value α may be, for example, several kilowatts, or the like.

In the hybrid vehicle 20 according to the embodiment, the basic charge/discharge required power Pbtmp inset for the charge/discharge required power Pb* when the catalyst temperature Tc is higher than or equal to the threshold Tcref and the vehicle speed V is higher than or equal to the threshold Vref; instead, the predetermined electric power Pdis may be set for the charge/discharge required power Pb* in this case.

In the hybrid vehicle 20 according to the embodiment, the basic charge/discharge required power, Pbtmp is set for the charge/discharge required power Pb* when the catalyst temperature Tc is lower than the threshold Tcref, when the state of charge SOC of the battery 50 is lower than the threshold Sref or when the vehicle speed V is higher than or equal to the threshold Vref. In addition, the predetermined electric power Pdis is set for the charge/discharge required power Pb* when the catalyst temperature Tc is higher than or equal to the threshold Tcref, the state of charge SOC of the battery 50 is higher than or equal to the threshold Sref and the vehicle speed V is lower than the threshold Vref. However, a charging and discharging electric power of the battery 50 just needs to be increase toward a discharging side in the latter case than in the former case. Therefore, the basic charge/discharge required power Pbtmp is set for the charge/discharge required power Pb*, and a value obtained by subtracting the charge/discharge required power Pb* (=Pbtmp) from the drive power Pdrv* may be set for the required power Pe* in the former case; whereas a value obtained by adding a positive predetermined value β to a value obtained by subtracting the charge/discharge required power Pb* (=Pbtmp) from the drive power Pdrv* may be set for the required power Pe*. Here, the predetermined value β may be, for example, several kilowatts, or the like.

In the hybrid vehicle 20 according to the embodiment, the catalyst temperature Tc is detected by the temperature sensor 134b installed in the purification system 134. Instead, it is applicable that the temperature sensor 134b is not provided and the temperature of the purification catalyst 134a may be estimated on the basis of an accumulated value of the intake air amount Qa, the intake air temperature Tin, the coolant temperature Tw, and the like.

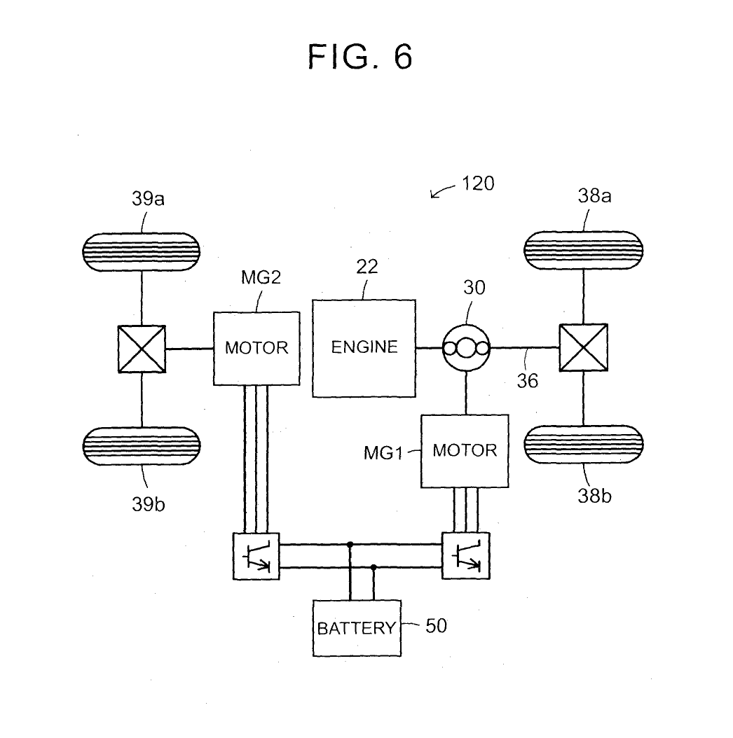

In the hybrid vehicle 20 according to the embodiment, power from the motor MG2 is output to the drive shaft 36. Instead, as in the case of a hybrid vehicle 120 according to an alternative embodiment shown in FIG. 6, power from the motor MG2 may be output to an axle different from an axle connected to the drive shaft 36. That is, power from the motor MG2 may be output to an axle connected to wheels 39a, 39b, different from an axle connected to the drive wheels 38a, 38b.

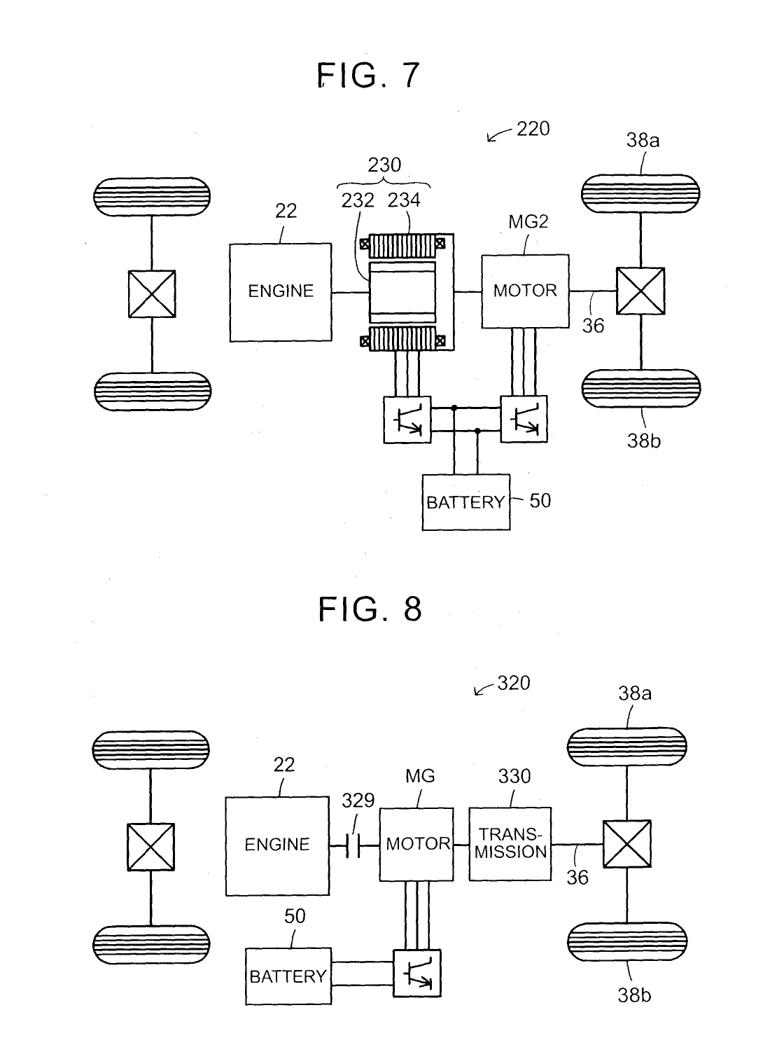

In the hybrid vehicle 20 according to the embodiment, power from the engine 22 is output to the drive shaft 36, connected to the drive wheels 38a, 38b, via the planetary gear unit 30. However, as in the case of a hybrid vehicle 220 according to an alternative embodiment shown in FIG. 7, a paired-rotor motor 230 may be provided. The paired-rotor motor 230 includes an inner rotor 232 connected to the crankshaft of the engine 22 and an outer rotor 234 connected to the drive shaft 36 that outputs power to the drive wheels 38a, 38b, transmits part of power from the engine 22 to the drive shaft 36 and converts the remaining power to electric power.

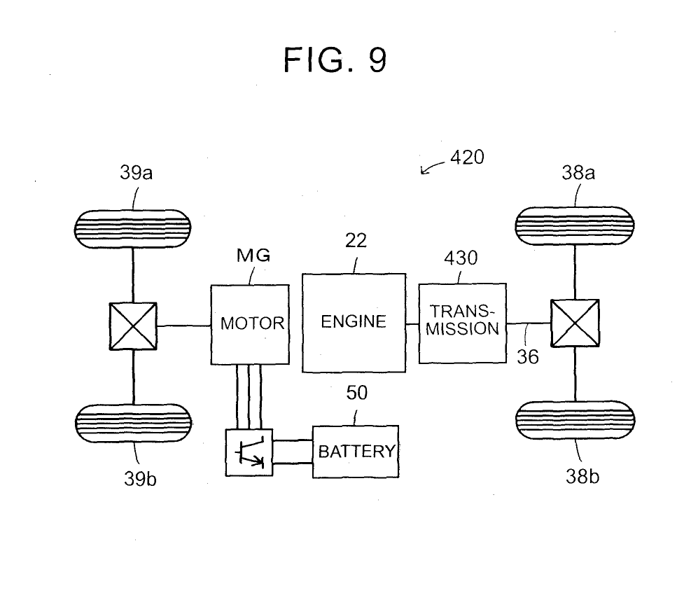

In the hybrid vehicle 20 according to the embodiment, power from the engine 22 is output to the drive shaft 36 connected to the drive wheels 38a, 38b via the planetary gear unit 30, and power from the motor MG2 is output to the drive shaft 36. However, as in the case of a hybrid vehicle 320 according to an alternative embodiment shown in FIG. 8, it is applicable that a motor MG is connected via a transmission 330 to the drive shaft 36 connected to the drive wheels 38a, 38b, and the engine 22 is connected to the rotary shaft of the motor MG via a clutch 329. In the hybrid vehicle 320, it is applicable that power from the engine 22 is output to the drive shaft 36 via the rotary shaft of the motor MG and the transmission 330 and power from the motor MG is output to the drive shaft 36 via the transmission 330. Alternatively, as in the case of a hybrid vehicle 420 according to an alternative embodiment shown in FIG. 9, it is applicable that power from the engine 22 is output via a transmission 430 to the drive shaft 36 connected to the drive wheels 38a, 38b and power from the motor MG is output to an axle different from an axle connected to the drive wheels 38a, 38b. That is, power from the motor MG is output to the axle connected to the wheels 39a, 39b shown in FIG. 9.

In the embodiment, the engine 22 corresponds to “engine”, the motor MG2 corresponds to “motor”, and the battery 50 corresponds to “battery”. The HVECU 70, the engine ECU 24 and the motor ECU 40 correspond to “control device”. The HVECU 70 executes the charge/discharge required power setting routine shown in FIG. 3 for setting the charge/discharge required power Pb* such that the charge/discharge required power Pb* increases when the catalyst temperature Tc is higher than or equal to the threshold Tcref lower than the degradation promoting lower limit temperature Tcmin as compared to when the catalyst temperature Tc is lower than the threshold Tcref, sets the required power Pe* on the basis of the drive power Pdrv* and the charge/discharge required power Pb*, sets the target rotation speed Ne* and target torque Te* of the engine 22, the torque command Tm1* of the motor MG1 and the torque command Tm2* of the motor MG2 such that the required power Pe* is output from the engine 22 and the required torque Tr* (drive power Pdrv*) is output to the drive shaft 36, and transmits the target rotation speed Ne*, the target torque Te*, the torque commands Tm1*, Tm2* to the engine ECU 24 and the motor ECU 40. The engine ECU 24 controls the engine 22 on the basis of the target rotation speed Ne* and the target torque Te* from the HVECU 70. The motor ECU 40 controls the motors MG1, MG2 on the basis of the torque commands Tm1*, Tm2* from the HVECU 70.

Here, the “engine” is not limited to the engine 22 that outputs power using gasoline, light oil, or the like, as fuel, and may be an engine of any type as long as a purification system having a purification catalyst that purifies exhaust gas is installed in an exhaust system of the engine and the engine is able to output drive power. The “motor” is not limited to the motor MG2 configured as a synchronous generator-motor and may be a motor of any type, such as an induction motor, as long as the motor is able to output drive power. The “battery” is not limited to the battery 50 configured as a lithium ion secondary battery and may be a battery of any type, such as a nickel metal hydride secondary battery, a nickel-cadmium secondary battery and a lead-acid battery, as long as the battery is able to exchange electric power, with the motor. The “control device” is not limited to a combination of the HVECU 70, the engine ECU 24 and the motor ECU 40, and may be formed of a single electronic control unit. In addition, the “control device” is not limited to the one that sets the charge/discharge required power Pb* such that the charge/discharge required power Pb* increases when the catalyst temperature Tc is higher than or equal to the threshold Tcref lower than the degradation promoting lower limit temperature Tcmin as compared to when the catalyst temperature Tc is lower than the threshold Tcref and that controls the engine 22 and the motors MG1, MG2 such that the required power Pe* obtained by subtracting the charge/discharge required power Pb* from the drive power Pdrv* is output from the engine 22 and the vehicle travels on the required torque Tr* (drive power Pdrv*). For example, the “control device” may be any control device as long as the control device controls the engine and the motors such that the vehicle travels on drive power while the battery is being charged or discharged and executes discharge-oriented control for controlling the vehicle such that the charging and discharging electric power of the battery tends to increase toward the discharging side when the temperature of the purification catalyst is higher than or equal to the predetermined temperature lower than the degradation promoting lower limit temperature of the purification catalyst as compared to when the temperature of the purification catalyst is lower than the predetermined temperature.

The major elements according to the embodiment are an example for specifically describing a mode for carrying out the invention, and do not limit the elements of the invention.

The mode for carrying out the invention is described using the embodiment; however, the invention is not limited to the above embodiment, and, of course, various modifications are applicable without departing from the scope of the invention.

The invention is usable in, for example, manufacturing industries for a hybrid vehicle.

1. A hybrid vehicle comprising:
an engine including a purification system and configured to output drive power, the purification system being installed in an exhaust system and having a purification catalyst that purifies exhaust gas;
a motor configured to output drive power;
a battery configured to exchange electric power with the motor; and
a control device configured to control the engine and the motor such that the hybrid vehicle travels on drive power while the battery is being charged or discharged,
the control device being configured to execute discharge-oriented control when a temperature of the purification catalyst is higher than or equal to a predetermined temperature, the predetermined temperature being lower than a degradation promoting lower limit temperature, and
in the discharge-oriented control, the control device being configured to control the engine and the motor such that a charging and discharging electric power of the battery increases toward a discharging side when the temperature of the purification catalyst is higher than or equal to the predetermined temperature as compared to when the temperature of the purification catalyst is lower than the predetermined temperature.

2. The hybrid vehicle according to claim 1, wherein
the control device is configured to allow fuel cut of the engine when the temperature of the purification catalyst is lower than the degradation promoting lower limit temperature and there is no output request for the engine, and
the control device is configured not to allow fuel cut of the engine when the temperature of the purification catalyst is higher than or equal to the degradation promoting lower limit temperature and there is no output request for the engine.

3. The hybrid vehicle according to claim 1 or 2, wherein
the control device is configured to control the engine and the motor such that the hybrid vehicle travels on the drive power while an engine required power based on the drive power and a battery required power is being output from the engine,
the control device is configured to set the battery required power to a state-of-charge corresponding power when the discharge-oriented control is not executed, the state-of-charge corresponding power being a power such that a state of charge of the battery approaches a target state of charge, and
the control device is configured to, when the discharge-oriented control is executed, set the battery required power to a power such that the charging and discharging power of the battery increases toward the discharging side as compared to a case where the battery required power is set to the state-of-charge corresponding power.

4. The hybrid vehicle according to any one of claims 1 to 3, wherein
the control device is configured not to execute the discharge-oriented control when the temperature of the purification catalyst is higher than or equal to the predetermined temperature and a vehicle speed is higher than or equal to a predetermined vehicle speed.

5. The hybrid vehicle according to any one of claims 1 to 4, wherein
the control device is configured not to execute the discharge-oriented control when the temperature of the purification catalyst is higher than or equal to the predetermined temperature and a state of charge of the battery is lower than a predetermined state of charge.

6. The hybrid vehicle according to any one of claims 1 to 5, further comprising:
a generator configured to exchange electric power with the battery; and
a planetary gear unit of which three rotating elements are respectively connected to a drive shaft coupled to an axle, an output shaft of the engine and a rotary shaft of the generator, wherein
a rotary shaft of the motor is connected to the drive shaft.

7. A control method for a hybrid vehicle, the hybrid vehicle including an engine, a motor and a battery, the engine including a purification system and being configured to output drive power, the purification system being installed in an exhaust system and having a purification catalyst that purifies exhaust gas, the motor being configured to output drive power, the battery being configured to exchange electric power with the motor, comprising:
controlling the engine and the motor such that the hybrid vehicle travels on drive power while the battery is being charged or discharged; and
determining whether a temperature of the purification catalyst is higher than or equal to a predetermined temperature lower than a degradation promoting lower limit temperature, wherein
discharge-oriented control is executed when the temperature of the purification catalyst is higher than or equal to the predetermined temperature, and
in the discharge-oriented control, the engine and the motor are controlled such that a charging and discharging electric power of the battery increases toward a discharging side when the temperature of the purification catalyst is higher than or equal to the predetermined temperature as compared to when the temperature of the purification catalyst is lower than the predetermined temperature.

8. The control method according to claim 7, further comprising:
determining whether the temperature of the purification catalyst is higher than or equal to the degradation promoting lower limit temperature; and
determining whether there is an output request for the engine, wherein
fuel cut of the engine is allowed when the temperature of the purification catalyst is lower than the degradation promoting lower limit temperature and there is no output request for the engine, and
fuel cut of the engine is not allowed when the temperature of the purification catalyst is higher than or equal to the degradation promoting lower limit temperature and there is no output request for the engine.

9. The control method according to claim 7 or 8, wherein
the engine and the motor are controlled such that the hybrid vehicle travels on the drive power while an engine required power based on the drive power and a battery required power is being output from the engine,
when the discharge-oriented control is not executed, the battery required power is set to a state-of-charge corresponding power such that a state of charge of the battery approaches a target state of charge, and
when the discharge-oriented control is executed, the battery required power is set to a power such that the charging and discharging power of the battery increases toward the discharging side as compared to a case where the battery required power is set to the state-of-charge corresponding power.

10. The control method according to any one of claims 7 to 9, further comprising:
determining whether a vehicle speed is higher than or equal to a predetermined vehicle speed, wherein
the discharge-oriented control is not executed when the temperature of the purification catalyst is higher than or equal to the predetermined temperature and the vehicle speed is higher than or equal to the predetermined vehicle speed.

11. The control method according to any one of claims 7 to 10, further comprising:
determining whether a state of charge of the battery is higher than or equal to a predetermined state of charge, wherein
the discharge-oriented control is not executed when the temperature of the purification catalyst is higher than or equal to the predetermined temperature and the state of charge of the battery is lower than the predetermined state of charge.
